(19) United States
(12) Patent Application Publication
(10) Pub. No.: US 2023/0025812 A1
(43) Pub. Date: Jan. 26, 2023

(54) CABIN CLIMATE CONTROL BASED ON CABIN OCCUPANCY

(71) Applicant: Rivian IP Holdings, LLC, Plymouth, MI (US)

(72) Inventors: Jamie W. Leadbetter, Woking (GB); Gavin Goodchild, Windsor (CA)

(21) Appl. No.: 17/385,034

(22) Filed: Jul. 26, 2021

(51) Int. Cl. B60H 1/00; B60H 3/06

(52) U.S. Cl. CPC B60H 1/00742; B60H 1/00778; B60H 3/06; B60H 1/00821

(57) ABSTRACT

Various disclosed embodiments include systems, vehicles, and controllers for vehicles. An illustrative system includes a climate control system configured to heat or cool a space and a controller configured to provide control signals to the climate control system. An occupancy sensor is configured to detect one or more occupants within the space and provide occupancy information to the controller. A door sensor is configured to detect open or closed status of a door and is configured to provide door status information to the controller. The control signals from the controller are based on a combination of the occupancy information and the door status information.

### INTRODUCTION

The present disclosure relates to vehicle cabin climate control. The statements in this section merely provide background information related to the present disclosure and may not constitute prior art.

People may leave their vehicles with the windows or doors open and climate control system (e.g., air conditioning) running as they leave their vehicle, for example, to evaluate the surroundings of the vehicle. During such actions, the energy used by the climate control system to condition the air is wasted, as the conditioned air escapes through the open window or door and does not contribute to occupant comfort, as occupants are not in the vehicle.

### BRIEF SUMMARY

Various disclosed embodiments include illustrative climate control systems, vehicles, and controllers for vehicles.

In an illustrative embodiment a system includes a climate control system configured to heat or cool a vehicle cabin and a controller configured to provide control signals to the climate control system. An occupancy sensor is configured to detect one or more occupants within the vehicle cabin and provide occupancy information to the controller. A door sensor is configured to detect open or closed status of a door and is configured to provide door status information to the controller. The control signals from the controller are generated based on a combination of the occupancy information and the door status information.

In another illustrative embodiment a vehicle includes a chassis, a passenger cabin supported by the chassis and having one or more door, one or more drive systems supported by the chassis and driving one or more wheels supported by the chassis, and a climate control system configured to heat or cool the passenger cabin. The vehicle also includes a controller configured to provide control signals to the climate control system. The vehicle also includes an occupancy sensor configured to detect one or more occupants within the passenger cabin and provide occupancy information to the controller. Further, the vehicle also includes a door sensor configured to detect open or closed status of the one or more doors and configured to provide door status information to the controller. The control signals are based on a combination of the occupancy information and the door status information.

In another illustrative embodiment a controller for a vehicle includes a processor and computer-readable media including computer-executable instructions configured to cause the processor to: provide control signals to a climate control system of a vehicle, the climate control system being configured to heat or cool a space; receive an occupancy signal from an occupancy sensor that is configured to detect one or more occupants within the vehicle; and receive a door signal from a door sensor configured to detect open or closed status of a door of the vehicle, wherein the control signals are provided to turn the climate control system off if the occupancy sensor signal indicates no occupant and the door signal indicates that the door is open.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIG. 1 is a block diagram in partial schematic form of an illustrative vehicle including various on-board systems.

FIG. 2 is a block diagram of an illustrative climate control system of the vehicle of FIG. 1.

FIG. 3 is a table depicting illustrative climate control logic.

FIG. 4 is a flow chart of an illustrative method of climate control for a vehicle.

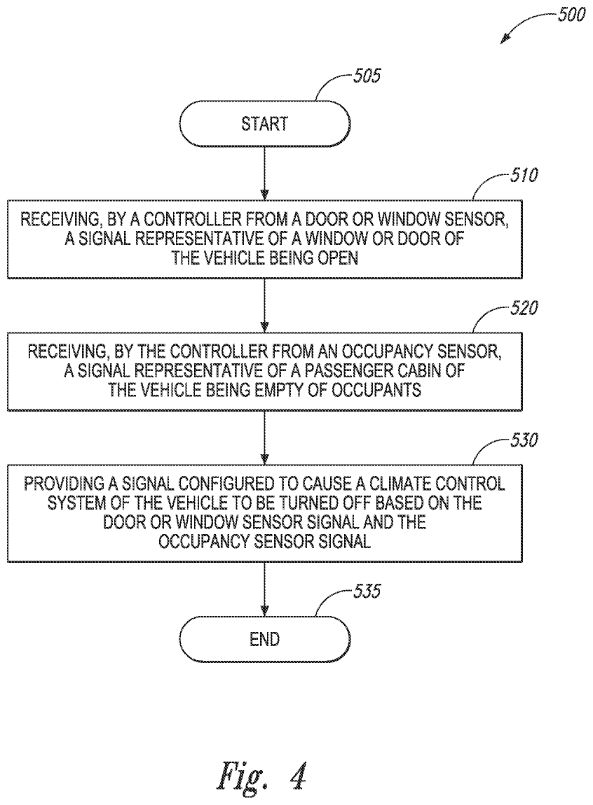

Like reference symbols in the various drawings generally indicate like elements.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Given by way of overview, various disclosed embodiments include illustrative climate control systems, vehicles, and controllers for vehicles. In an illustrative embodiment a system includes a climate control system configured to heat or cool a space and a controller configured to provide control signals to the climate control system. An occupancy sensor is configured to detect one or more occupants within the space and provide occupancy information to the controller. A door sensor is configured to detect open or closed status of a door and is configured to provide door status information to the controller. The control signals from the controller are based on a combination of the occupancy information and the door status information.

Now that an overview has been given, details will be set forth below by way of non-limiting examples given by way of illustration only and not of limitation.

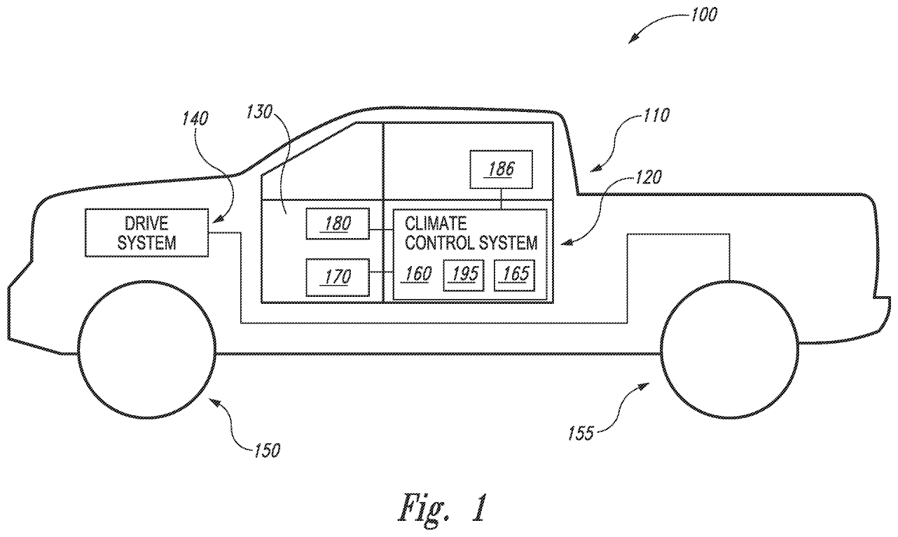

Referring now to FIG. 1, in various embodiments a vehicle 100 includes a climate control system 160. The vehicle 100 may be any type of vehicle including but not limited to a car, a truck, a van, a motorhome, or the like. In various embodiments the vehicle 100 may include a chassis or vehicle body 110. A passenger cabin 120 may be supported by the chassis 110 and have one or more doors 130 for ingress to and egress from the cabin 120, one or more windows 115, and one or more seats (not shown). One or more drive systems 140 are supported by the chassis 110 and are configured to drive one or more wheels 150 and 155 that are supported by the chassis 110. In accordance with various embodiments, the drive system 140 may be any variety of drive systems including but not limited to internal combustion engines, hybrid drive systems, electrical drive motors, and the like.

The climate control system 160 may be configured to heat or cool the passenger cabin 120. In various embodiments the climate control system 160 may include a heating system, a cooling system, a heating and cooling system, a heating, ventilation, and air conditioning (HVAC) system, or the like. In various embodiments, portions of the climate control system 160 may be configured to heat or cool portions of the passenger cabin 120 (e.g., a front passenger region, rear passenger region, etc. not shown) separately. For example, a front passenger region of passenger cabin 120 may be configured to be heated or cooled at a different temperature or rate than a rear passenger region of passenger cabin 120. Moreover, in various embodiments, portions of the climate control system 160 may be configured to heat or cool specific elements within the passenger cabin 120, for example, a window or windshield (e.g., via a defroster), passenger seats (e.g., via seat conditioning features such as seat warmers or seat ventiliation), seats/storage configured for pet travel (e.g., via vents directed to an area separated by a pet barrier), or areas configured for storage of electronic devices (e.g., vents directed to device storage areas).

In various embodiments the climate control system 160 may include an air filtration system 195. In various embodiments the air filtration system 195 may be configured to filter air of the passenger cabin 120. In various embodiments, the air filtration system 195 may be capable of exchanging the entire volume of cabin air in a short period of time. Such filtration systems may be applied in vehicles so that, in the case that the cabin becomes filled with exhaust fumes or other odorous or toxic-laden air, the cabin air may be exchanged very quickly, thereby providing clean, filtered air to the occupants of the passenger cabin 120. Air filtering system 195 may include an input bringing outside (or inside) air to pass through a filter which may be a paper or synthetic filter having pore sizes of any sort, for example pore sizes may be consistent with HEPA or MERV 13, however any filter may be used based on performance and design considerations.

In various embodiments, the climate control system 160 may include, among other components, a controller 165 that is configured to provide control signals to the climate control system 160.

In various embodiments the vehicle 100 also may include any of a variety of sensors. For example, in various embodiments one or more occupancy sensors 170 may be configured to detect one or more occupants (e.g., a driver, passenger, or pet) within the passenger cabin 120 and provide occupancy information to the controller 165. In various embodiments, an occupancy sensor 170 may be any of a variety of sensors including but not limited to seat sensors, capacitive sensors, optical sensors, weight sensors, cameras, and the like. In various embodiments, the one or more occupancy sensors 170 may be configured to detect (and the occupancy information thereby configured to indicate) that any occupant is within the vehicle cabin 120 or that occupants are within certain seats or regions of the vehicle cabin 120. In various embodiments, one or more device sensors 190 may be configured to detect the presence of a user device (e.g., a smartphone) within the vehicle cabin 120 (e.g., in a device storage area) and provide device information to the controller.

As another example, in various embodiments one or more door sensors 180 may be configured to detect open or closed status of the one or more doors 130 and provide door status information to the controller 165. In various embodiments the door sensors 180 and associated door status information may either indicate simply an open or closed state or in other cases may indicate a closed state or a quantitative amount of the open state (e.g. 10% open or 35% open, or, alternatively, an amount of linear displacement of the door such as 2 inches open or the like). In various embodiments, a door sensor 180 may be any of a variety of sensors including but not limited to mechanical switches, potentiometers, hinge sensors, capacitive sensors, optical sensors, cameras, and the like.

As another example, in various embodiments one or more window sensors 186 may be configured to detect open or closed status of the one or more windows 115 and provide window status information to the controller 165. In various embodiments the window sensors 186 and associated window status information may either indicate simply an open or closed state or in other cases may indicate a closed state or a quantitative amount of the open state (e.g. 10% open or 35% open, or, alternatively, an amount of linear displacement of the window such as 2 inches open or the like). In various embodiments the window sensors 186 may include but are not limited to electromechanical sensors, potentiometers, capacitive sensors, optical sensors, displacement sensors, and the like.

In accordance with various embodiments and as will be explained below, the control signals from the controller 165 may be based on a combination of the occupancy information from the occupancy sensor 170 and the door status information from the door sensors 180 or the window status information from the window sensors 186.

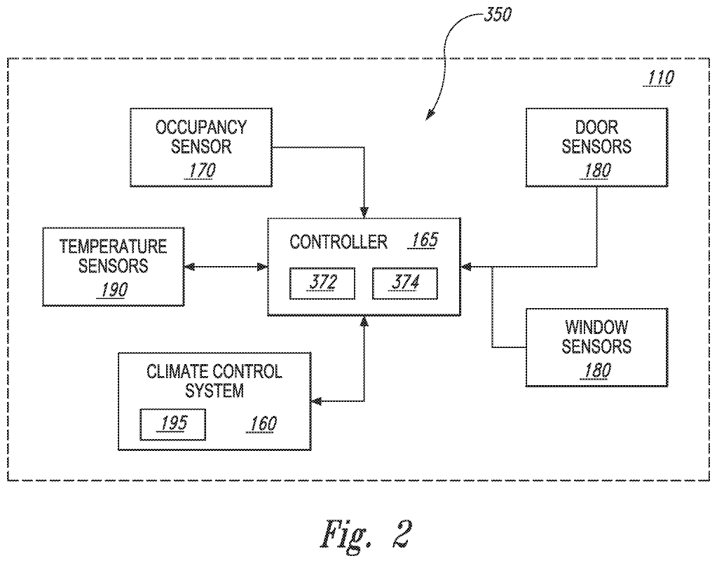

Referring additionally to FIG. 2, in various embodiments the system 350 may include the controller 165. In various embodiments, the controller 165 may include a processor 372 capable of executing program instructions which may be stored in a computer-readable media (or memory) 374. The processor 372 may be any of a variety of processing device including but not limited to microprocessors, ASICS, Floating Point Gate Arrays (FPGAs), and the like. The memory 374 may include any of a variety of memory types including but not limited to volatile memory, non-volatile memory, and the like.

It may be common for a driver to open the vehicle door 130, exit the vehicle 100, to inspect the path or obstacles in the path of the vehicle 100 (for example, in an off-roading scenario) or make a quick delivery outside of the vehicle (for example, in a delivery scenario). In such situations the driver may opt to leave the door 130 open as a matter of quickness, forgetfulness, or brevity. When the door 130 is left open, climate controlled air (air hotter or colder than outside air temperature) may be exchanged with outdoor air. This exchange can waste energy (e.g., further drain the vehicle batteries or other energy source). For example, with the door 130 open, without intervention as discussed below, the climate control system 160 may struggle to reach a set point as sensed by temperature sensors 172. Once the door 130 is re-closed when the driver gets back in the vehicle 100, without intervention as discussed below, the climate control system 160 may use substantial energy to get back to the set point temperature.

In various embodiments, the control signals from the controller 165 may be based on a combination of the occupancy information from the occupancy sensor 170 and the door status information from the door sensors 180 or the window sensors 186 to help contribute to reducing the amount of energy used by the climate control system 160 while a driver is out of the vehicle 100.

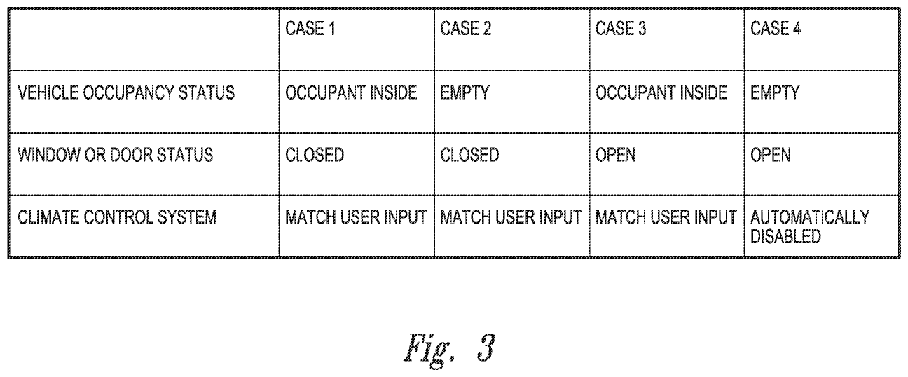

To that end and referring additionally to FIG. 3, in various embodiments the controller 165 may be configured to turn the climate control system 160, or portions of the climate control system 160, off when the door status information is representative of the door 130 being open or the window status information is representative of a window being open and the occupancy information is representative of the space being empty of occupants. This logic is represented in the logic table provided as FIG. 3. As indicated in the logic table shown in FIG. 3, if the system 350 detects no occupants are inside of the vehicle cabin 120 and that a door 130 or window 115 is open (e.g., via door sensor 180 or window sensor 186), then the climate control system 160 (or portions of the climate control system) are turned off until system 350 detects an occupant is within the vehicle cabin 120 or the door 130 or window 115 is no longer open.

In various embodiments, the system 350 may be configured to only turn off portions of the climate control system 160 in response to certain doors 130 or windows 115 being opened, or in response to certain passenger areas being occupied or unoccupied within vehicle cabin 120. For example, If the system 350 detects that a front vehicle door or front vehicle window is open and no occupants are within a front passenger region of the vehicle cabin 120 (i.e., that no driver or passenger are present in a front seat) but that one or more occupants are present within a rear passenger region of the vehicle cabin 120 (i.e., one or more passengers are present in a back seat of the vehicle), then the system 350 may be configured to turn off only the portion of climate control system 160 that is conditioning the air of the front passenger region of the vehicle, while continuing to condition the air of the rear passenger region of the vehicle.

In various embodiments, the system 350 may be configured to turn portions of the climate control system 160 (e.g., general cabin conditioning) off as set forth above, but may be further configured to keep portions of the climate control system 160 active in order to condition certain elements within the vehicle cabin 120. For example, if the system 350 detects that an occupant was previously occupying a seat of the vehicle (e.g., using occupancy information from occupancy sensor 170), then the system may be configured turn off portions of climate control system 160 as set forth above (e.g., the cabin conditioning configured to cool the cabin space generally), while continuing to operate seat conditioning features of the climate control system 160 (e.g., seat warming or cooling via seat ventilation) even when the occupant is not present and a window or door is open. Such implementations can keep the occupants' seat at a comfortable temperature without wasting further energy usually used by the cabin conditioning features of the climate conditioning system 160 to cool the rest of vehicle cabin 120. Similarly, the system 350 may be configured to detect the presence of an electronic device (e.g., using a device information from device sensor 190) and continue to operate portions of the climate conditioning system 160 configured to warm or cool the area where the device is stored, while turning off other portions of the climate control system 160 as set forth above. Similarly, the system 350 may be configured to operate certain portions of the climate conditioning system 160 to heat or cool other elements, such as an area configured for pet transport, regardless of whether a door or window is open. In various embodiments, the system 350 may be used when the climate control system 160 includes the air filtration system 195. In such cases, the controller 165 is configured to turn the air filtration system 195 on when the door status information is representative of the door 130 being recently closed or the window status information is representative of a window being recently closed and the occupancy information is representative of the space containing one or more occupants. Thus, in such embodiments, the system 350 may be used to not only shut down the climate control system 160 under certain sensed conditions but may also be used to filter the cabin air once the occupants reenter the passenger cabin 120.

In various embodiments, window status information from window sensors 186 may indicate a quantitative amount of open state of the window (e.g., 10% open) rather than a simple open or closed state. In such embodiments, the system 350 may determine that the window is open (i.e., as applied to the logic table shown in FIG. 3), when the quantitative open state of the window passes a certain threshold (e.g., in the range of 35%-50% open). Similarly, door status information from door sensors 180 may indicate a quantitative amount of open state of the door (e.g., 10% open) rather than a simple open or closed state, and the system 350 may likewise determine that the door is open (e.g., as applied to the logic table shown in FIG. 3), when the quantitative open state of the door passes a certain threshold (e.g., in the range of 25%-50% open).

Referring now to FIG. 5, a method 500 of climate control begins at a block 505. At a block 510, the method 500 proceeds with receiving, by a controller, from a door or window sensor, a signal representative of a window or door of the vehicle being open. At a block 520, the controller receives, from an occupancy sensor, a signal representative of a passenger cabin of the vehicle being empty of occupants. At a block 530, a signal configured to cause a climate control system of the vehicle to be turned off based on the door or window sensor signal and the occupancy sensor signal is provided to the climate control system. The method 500 ends at a block 535. Various other steps may be used in the process without departing from the scope of the disclosure.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (for example “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware.

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those skilled in the art that various modifications can be made thereto without departing from the scope of the claimed subject matter as set forth in the claims.

What is claimed is:

1. A system comprising:
a climate control system configured to heat or cool a vehicle cabin;
a controller configured to provide control signals to the climate control system;
an occupancy sensor configured to detect one or more occupants within the vehicle cabin and provide occupancy information to the controller; and
a door sensor configured to detect an open status of a door and configured to provide door status information to the controller, wherein the control signals are generated based on a combination of the occupancy information and the door status information.

2. The system of claim 1, wherein:
the vehicle cabin includes one or more passenger regions;
the occupancy information indicates a location of the one or more occupants within the passenger regions; and
the control signals are generated based on the location of the one or more occupants within the passenger regions.

3. The system of claim 2, wherein the climate control system controller is further configured to:
turn the climate control system off in a first passenger region and keep the climate control system on in a second passenger region when the door status information is representative of the door being open and the occupancy information is representative of the first passenger region being empty of occupants and the second passenger region being occupied by occupants.

4. The system of claim 1, wherein the climate control system includes at least one of an air conditioning system or a heating system.

5. The system of claim 1, wherein the climate control system includes an air filtration system.

6. The system of claim 1, wherein the controller is further configured to turn the climate control system off when the door status information is representative of the door being open and the occupancy information is representative of the vehicle cabin being empty of occupants.

7. The system of claim 1, wherein:
the climate control system includes a seat conditioning system and a cabin conditioning system; and
the controller is further configured to turn the cabin conditioning system off and keep the seat conditioning system on when the door status information is representative of the door being open and the occupancy information is representative of the vehicle cabin being empty of occupants.

8. The system of claim 1, further comprising:
a window sensor configured to detect the open or closed status of a window and configured to provide window status information to the controller.

9. The system of claim 8, wherein the controller is further configured to turn the climate control system off when the window status information is representative of the window being open and the occupancy information is representative of the vehicle cabin being empty of occupants.

10. The system of claim 9, wherein:
the window status information further includes a quantitative amount of an open state of the window, and the status controller determines that the window status information is representive of the window being open when the quantitative amount of the open state of the window exceeds a threshold.

11. The system of claim 1, wherein:
the climate control system includes an air filtration system; and
the controller is further configured to turn the air filtration system on when the door status information is representative of the door being recently closed and the occupancy information is representative of the vehicle cabin containing one or more occupants.

12. A vehicle comprising:
a chassis;
a passenger cabin supported by the chassis and having one or more doors;
one or more drive systems supported by the chassis and driving one or more wheels supported by the chassis; and
a climate control system configured to heat or cool the passenger cabin, the climate control system including;
a controller configured to provide control signals to the climate control system;
an occupancy sensor configured to detect one or more occupants within the passenger cabin and provide occupancy information to the controller; and
a door sensor configured to detect open or closed status of the one or more door and configured to provide door status information to the controller, wherein the control signals from the controller are generated based on a combination of the occupancy information and the door status information.

13. The vehicle of claim 12, wherein the climate control system includes at least one of an air conditioning system or a heating system.

14. The vehicle of claim 12, wherein the controller is further configured to turn the climate control system off when the door status information is representative of the door being open and the occupancy information is representative of the passenger cabin being empty of occupants.

15. The vehicle of claim 12, wherein:
the climate control system includes a seat conditioning system and a passenger cabin conditioning system; and
the controller is further configured to turn the passenger cabin conditioning system off and keep the seat conditioning system on when the door status information is representative of the door being open and the occupancy information is representative of the passenger cabin being empty of occupants.

16. The vehicle of claim 12, further comprising:
a passenger cabin window; and
a window sensor configured to detect open or closed status of the window and configured to provide window status information to the controller.

17. The vehicle of claim 16, wherein the controller is further configured to turn the climate control system off when the window status information is representative of the window being open and the occupancy information is representative of the passenger cabin being empty of occupants.

18. The vehicle of claim 16, wherein:
the climate control system includes an air conditioning system; and
the controller is further configured to turn the air conditioning system off when the window status information is representative of the window being open and the occupancy information is representative of the passenger cabin being empty of occupants.

19. The vehicle of claim 12, wherein:
the climate control system includes an air filtration system; and
the controller is configured to turn the air filtration system on when the door status information is representative of the door being recently closed and the occupancy information is representative of the space containing one or more occupants.

20. A controller for a vehicle, the controller comprising:
a processor; and
computer-readable media including computer-executable instructions configured to cause the processor to:
provide control signals to a climate control system of a vehicle, the climate control system being configured to heat or cool a space;
receive an occupancy signal from an occupancy sensor that is configured to detect one or more occupants within the vehicle; and
receive a door signal from a door sensor configured to detect open or closed status of a door of the vehicle, wherein the control signals are provided to turn the climate control system off if the occupancy sensor signal indicates no occupant and the door signal indicates that the door is open.
